(19) United States
(12) Patent Application Publication
(10) Pub. No.: US 2025/0222353 A1
(43) Pub. Date: Jul. 10, 2025

(54) VIRTUAL SCENE INTERACTION METHOD AND APPARATUS

(71) Applicant: Tencent Technology (Shenzhen) Company Limited, Shenzhen (CN)

(72) Inventors: Yixuan Wang, Shenzhen (CN); Shihao LI, Shenzhen (CN); Muyu XU, Shenzhen (CN); Zhiwei WANG, Shenzhen (CN)

(21) Appl. No.: 19/089,391

(22) Filed: Mar. 25, 2025

Related U.S. Application Data
(63) Continuation of application No. PCT/CN2024/083824, filed on Mar. 26, 2024.

(30) Foreign Application Priority Data
Mar. 17, 2023 (CN) 2023103013746

(51) Int. Cl. A63F 13/52; A63F 13/537

(52) U.S. Cl. CPC A63F 13/52; A63F 13/537

(57) ABSTRACT

A virtual scene interaction method, apparatus, electronic device, computer-readable storage medium, and computer program product are provided herein. The virtual scene interaction method includes outputting for display in a graphical user interface a virtual scene, a skill selection control, and a skill release control, the virtual scene comprising a first virtual object and the skill release control being in a first display style, switching the skill release control from the first display style to a second display style in response to a trigger operation for the skill selection control, the second display style representing that the skill release control is currently associated with a second skill, and controlling the first virtual object to release the second skill of the target type in response to a trigger operation for the skill release control.

### RELATED APPLICATION

This application is a continuation application of PCT Application PCT/CN2024/083824, filed Mar. 26, 2024, which claims priority to Chinese Patent Application No. 2023103013746, filed on Mar. 17, 2023, each entitled “VIRTUAL SCENE INTERACTION METHOD AND APPARATUS, ELECTRONIC DEVICE, COMPUTER-READABLE STORAGE MEDIUM, AND COMPUTER PROGRAM PRODUCT”, and each which is incorporated herein by reference in its entirety.

### FIELD

This application relates to the field of human-computer interaction technologies, and in particular, to a virtual scene interaction method, apparatus, electronic device, computer-readable storage medium, and computer program product.

### BACKGROUND

A human-computer interaction technology for a virtual scene based on graphics processing hardware can implement, according to an actual application requirement, diversified interaction between virtual objects controlled by a user or artificial intelligence, and has broad practical value. For example, in a virtual scene such as a game, a real combat process between virtual objects can be simulated.

Using an open world game as an example, in a related technology, a multi-role setting is usually used, and a player needs to frequently switch between roles and use a corresponding role capability in a combat or during exploration in the wild. As can be seen, in solutions provided in the related technology, during skill switching, switching operations are relatively complex, causing relatively low efficiency of skill switching, and further affecting game experience of the player.

### SUMMARY

One or more aspects described herein provide a virtual scene interaction method, apparatus, electronic device, computer-readable storage medium, and computer program product, which can improve efficiency of skill switching in a virtual scene, thereby improving game experience of a player and reducing resource overheads of a terminal device.

Technical solutions in the one or more aspects described herein include but are not limited to:

One or more aspects described herein provides a virtual scene interaction method, performed by an electronic device and including:

outputting for display in a graphical user interface a virtual scene, a skill selection control, and a skill release control, the virtual scene comprising a first virtual object, the skill release control being in a first display style, and the first display style representing that the skill release control is currently associated with a first skill;

switching the skill release control from the first display style to a second display style in response to a trigger operation for the skill selection control, the second display style representing that the skill release control is currently associated with a second skill, the second skill comprising a plurality of types, and the skill selection control used for selecting one target type from the plurality of types; and

controlling the first virtual object to release the second skill of the target type in response to a trigger operation for the skill release control.

One or more aspects described herein provides a virtual scene interaction apparatus, comprising one or more processors and memory storing computer-readable instructions that when executed by the one or more processors, cause the apparatus to:
output for display in a graphical user interface a virtual scene, a skill selection control, and a skill release control, the virtual scene comprising a first virtual object, the skill release control being in a first display style, and the first display style representing that the skill release control is currently associated with a first skill;
switch the skill release control from the first display style to a second display style in response to a trigger operation for the skill selection control, the second display style representing that the skill release control is currently associated with a second skill, the second skill comprising a plurality of types, and the skill selection control used for selecting one target type from the plurality of types; and
control the first virtual object to release the second skill of the target type in response to a trigger operation for the skill release control.

One or more aspects described herein provides an electronic device, including:
a memory, configured to store executable instructions; and
a processor, configured to implement the virtual scene interaction method when executing the executable instructions stored in the memory.

One or more aspects described herein provides a non-transitory computer-readable storage medium, having computer executable instructions stored thereon, the computer executable instructions being configured to: when executed by a processor, implement the virtual scene interaction method provided herein.

One or more aspects described herein provides a computer program product, including a computer program or computer executable instructions, the computer program or the computer executable instructions being configured to: when executed by a processor, implement the virtual scene interaction method provided herein.

The one or more aspects described herein have at least the following beneficial effects:

Through linkage between a skill selection control and a skill release control, a player can quickly switch to a second skill that needs to be released, and can select, by using the skill selection control, a second skill of a target type from a plurality of types of second skills to be released. In this way, efficiency of skill switching in a virtual scene is improved, and compared with a solution provided in a related technology, game experience of the player is improved, operation operations are simplified, and resource overheads of a terminal device can also be reduced.

### BRIEF DESCRIPTION OF THE DRAWINGS

FIG. 1 is an example of a schematic architecture diagram of a virtual scene interaction system 100 according to one or more aspects described herein.

FIG. 2 is an example of a schematic structural diagram of an electronic device according to one or more aspects described herein.

FIG. 3 is an example of a schematic flowchart of a virtual scene interaction method according to one or more aspects described herein.

FIG. 4 is an example of a schematic flowchart of a virtual scene interaction method according to one or more aspects described herein.

FIG. 5 is an example of a schematic flowchart of a virtual scene interaction method according to one or more aspects described herein.

FIG. 6A to FIG. 6E are examples of schematic diagrams of application scenarios of a virtual scene interaction method according to one or more aspects described herein.

FIG. 7 is an example of a schematic diagram of a virtual scene interaction method according to one or more aspects described herein.

FIG. 8 is an example of a schematic diagram of a virtual scene interaction method according to one or more aspects described herein.

FIG. 9 is an example of a schematic diagram of a virtual scene interaction method according to one or more aspects described herein.

FIG. 10 is an example of a schematic diagram of a virtual scene interaction method according to one or more aspects described herein.

FIG. 11 is an example of a schematic diagram of a virtual scene interaction method according to one or more aspects described herein.

FIG. 12 is an example of a schematic diagram of a virtual scene interaction method according to one or more aspects described herein.

FIG. 13 is an example of a schematic diagram of a virtual scene interaction method according to one or more aspects described herein.

### DETAILED DESCRIPTION

To make the objectives, technical solutions, and advantages of this application clearer, the following describes this application in further detail with reference to the accompanying drawings. The described aspects are not to be considered as a limitation. All other aspects obtained by a person of ordinary skill in the art without creative efforts shall fall within the protection scope.

In the following description, the term “some aspects” describes subsets of all possible aspects, but “some aspects” may be the same subset or different subsets of all the possible aspects, and can be combined with each other without conflict.

Data related to user information and the like (for example, data of a game character controlled by a user) may be involved in aspects described herein. When the one or more aspects described herein are applied to a specific product or technology, the user's permission or consent may need to be obtained, and collection, use, and processing of the relevant data may need to comply with relevant laws, regulations, and standards of relevant countries and regions.

In the following description, the term “first\second\ . . . ” is merely configured for distinguishing between similar objects, and does not represent a specific sorting for the objects. A specific sequence or an order of “first\second\ . . . ” may be interchanged when allowed, so that the one or more aspects described herein described herein can be implemented in a sequence other than that shown or described herein.

In one or more aspects described herein, the term “module” or “unit” may refer to a computer program having a predetermined function or a part of a computer program, and may work together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

Unless otherwise defined, meanings of all technical and scientific terms used in this description are the same as those usually understood by a person skilled in the art. Terms used in one or more aspects described herein are merely intended to describe objectives, but are not intended to limit the one or more aspects described herein.

Before the one or more aspects described herein are further described in detail, a description of certain terms is provided below.
1) In response to: refers to a condition or a state on which an operation to be performed depends. When the dependent condition or state is satisfied, one or more operations may be performed in real time or may have a specified delay. Unless otherwise specified, there is no limitation on an execution sequence of a plurality of operations performed.
2) Virtual scene: refers to a scene that an application program displays (or provides) when running on a terminal device. The scene may be a simulated environment of a real world, or may be a semi-simulated and semi-fictional virtual environment, or may be a completely fictional virtual environment. The virtual scene in the one or more aspects described herein may be a three-dimensional virtual scene. For example, the virtual scene may include a sky, a land, a sea, and the like. The land may include environment elements such as a desert and a city, and a user may control a virtual object to move in the virtual scene.
3) Virtual object: refers to an image of various people and objects that can interact in a virtual scene, or a movable object in a virtual scene. The movable object may be a virtual character, a virtual animal, a cartoon character, or the like, for example, a character or an animal displayed in a virtual scene. The virtual object may be a virtual image that is in the virtual scene and that is configured for representing a user. The virtual scene may include a plurality of virtual objects, and each virtual object has a shape and a size in the virtual scene, and occupies some space in the virtual scene.
4) Scene data: refers to feature data of a virtual scene, for example, may be an area of a construction region in the virtual scene or a current building style of the virtual scene and may also include a location of a virtual building in the virtual scene, a floor area occupied by the virtual building, and the like.
5) Open world game: is also referred to as free roam and may be a game mission design, in which a player can freely roam in a virtual world, and can freely select a time point and a manner for completing a game task.
6) Active state: refers to a state in which a skill of a virtual object is already enabled and can be normally used. For example, a player may activate a skill by tapping a particular button in a game scene.
7) Cloud game: is also referred to as gaming on demand, that is, a game program may be deployed in a server, an instance (briefly referred to as a game instance) of the game program may be run, the game instance may send game data outputted in a running process to a page of a browser of a user terminal, and the page may invoke a media component of the browser to decode the game data, and may render a real-time game picture in a game process according to a decoding result. When the page monitors an operation performed by the user in the game picture, the page may report the operation to the game instance running in the server. When game data of a response operation generated by the game instance is received, the decoding and rendering process may be repeated, so that the change of the game picture according to the operation of the user is presented on the page.

That is, a cloud game may be an online gaming technology based on a cloud computing technology. The cloud gaming technology may enable a thin client with relatively limited graphics processing and data computing capabilities to run high-quality games. In a cloud game scene, a game is not run in a user terminal (for example, a player game terminal), but may be run in a cloud server, and the cloud server may render the game scene into an audio and video stream and transmit the audio and video stream to the user terminal by using a network. In this way, the user terminal does not need to have a strong graphic operation capability and a data processing capability, and only needs to have a basic streaming media play capability and a capability of obtaining a player input instruction and sending the audio and video stream to the cloud server.
8) Display style: refers to an appearance design of a skill control in a game scene and for example, may include an icon, a color, and a size of the skill control. Display styles corresponding to different skill controls may be different.
9) Charge state: refers to a preparation stage that a game character needs to pass through to release a special skill or launch a powerful attack. A player may accumulate energy or a preparation condition by inputting a specific instruction or waiting for a period of time. Once completing charging, the game character may launch a more powerful skill.

One or more aspects described herein provide a virtual scene interaction method, apparatus, electronic device, computer-readable storage medium, and computer program product, which can improve efficiency of skill switching in a virtual scene. For understanding the virtual scene interaction method provided in the one or more aspects described herein is described. A virtual scene in the virtual scene interaction method provided in the one or more aspects described herein may be completely outputted based on a terminal device, or may be outputted based on cooperation between a terminal device and a server.

For example, for a standalone game application, when visual perception of the virtual scene is formed, the terminal device may compute, by using graphic computing hardware, data required for display, completes loading, parsing, and rendering of display data, and outputs, in graphic output hardware, a video frame that can form visual perception of the virtual scene, for example, may present a two-dimensional video frame on a display screen of a smartphone, or projects, on a lens of augmented reality/virtual reality glasses, a video frame that implements a three-dimensional display effect. In addition, to enrich the perceptual effect, the terminal device may further form one or more of auditory perception, tactile perception, motion perception, and gustatory perception by using different hardware.

For example, for an online game application, forming visual perception of a virtual scene is used as an example. A server may calculate display data (for example, scene data) related to the virtual scene and may send the display data to a terminal device by using a network. The terminal device may rely on graphic computing hardware to complete loading, parsing, and rendering of the calculated display data, and may rely on graphic output hardware to output the virtual scene to form visual perception. For example, a two-dimensional video frame may be presented on a display screen of a smartphone, or a video frame for implementing a three-dimensional display effect may be projected on a lens of augmented reality/virtual reality glasses. For perception in the form of a virtual scene, corresponding hardware outputs of the terminal device may be used, for example, a microphone may be configured for forming auditory perception, and a vibrator may be configured for forming tactile perception.

An electronic device provided in the one or more aspects described herein may be implemented as a terminal device, or may be implemented through cooperation between a terminal device and a server. The following uses an example in which the terminal device and the server cooperate to implement the virtual scene interaction method provided in the one or more aspects described herein for description.

Before introducing the architecture of the virtual scene interaction system, a game mode is first described. A solution for coordinated implementation of the terminal device and the server mainly involves two game modes: a local game mode and a cloud game mode. The local game mode refers to a instance where the terminal device and the server cooperatively run game processing logic, an operation instruction entered by a player in the terminal device, a part of which may be processed by the terminal device by running game logic, and the other part of which may be processed by the server by running game logic. In addition, game logic processing rung by the server is often more complex, and more computing power needs to be consumed. The cloud game mode indicates that the server (for example, a cloud server) may run game logic processing, and the cloud server may render game scene data into audio and video streams, and then may transmit the audio and video streams to the terminal device by using a network for display. That is, the terminal device only needs to have a basic streaming media playback capability and a capability of obtaining an operation instruction of a player and sending the operation instruction to the server.

The following describes the architecture of the virtual scene interaction system.

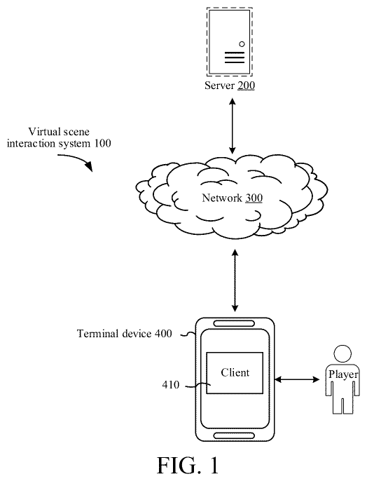

For example, referring to FIG. 1, FIG. 1 is an example of a schematic architecture diagram of a virtual scene interaction system 100 according to one or more aspects described herein. To implement an application that supports improving efficiency of skill switching in a virtual scene, as shown in FIG. 1, the virtual scene interaction system 100 may include: a server 200, a network 300, and a terminal device 400. The network 300 may be a local area network, a wide area network, or a combination thereof. The terminal device 400 may be a terminal device associated with a player. A client 410 may run on the terminal device 400. The client 410 may be an online game application, for example, including any one of an open world game, a shooting game, a virtual reality application program, a three-dimensional map program, a card strategy game, a sports game, a three-dimensional game, or a multiplayer shooter survival game.

The server 200 may calculate display data (for example, scenario data) related to a virtual scene and may send the display data to the terminal device 400 by using the network 300, so that the terminal device 400 may perform rendering based on the display data, and may display the virtual scene, a skill selection control, and a skill release control in a human-computer interaction interface of the client 410. The virtual scene may include a first virtual object (for example, a game character A controlled by a player), the skill release control may be in a first display style, and the first display style represents that the skill release control may be currently associated with a first skill (for example, a prop throwing skill). Then, when receiving a trigger operation (for example, a tap operation or a press operation) of the player on the skill selection control, the client 410 may switch the skill release control from the first display style to a second display style. The second display style represents that the skill release control may be currently associated with a second skill (for example, a magic skill). The second skill may include a plurality of types (for example, including star magic and wind field magic). The skill selection control may be configured to select a target type from the plurality of types. Subsequently, when receiving a trigger operation of the player for the skill release control, the client 410 may control the first virtual object to release the second skill of the target type. In this way, interaction between the skill selection control and the skill release control may be configured for improving efficiency of skill switching in the virtual scene.

The virtual scene interaction method may also be implemented by the terminal device alone. The terminal device 400 shown in FIG. 1 is used as an example. The terminal device 400 may calculate, by using graphic computing hardware, needed data for display, and may complete loading, parsing, and rendering of the display data, to display a virtual scene, a skill selection control, and a skill release control in a human-computer interaction interface of the client 410 (for example, a standalone game application). The virtual scene may include a first virtual object (for example, a game character A controlled by a player), the skill release control may be in a first display style, and the first display style may represent that the skill release control is currently associated with a first skill. Then, when receiving a trigger operation (for example, a tap operation or a press operation) of the player on the skill selection control, the client 410 may switch the skill release control from the first display style to a second display style. The second display style may represent that the skill release control is currently associated with a second skill (for example, a magic skill). The second skill may include a plurality of types (for example, including star magic and wind field magic). The skill selection control may be configured to select a target type from the plurality of types. Subsequently, when receiving a trigger operation of the player for the skill release control, the client 410 may control the first virtual object to release the second skill of the target type. In this way, interaction between the skill selection control and the skill release control may be configured for improving efficiency of skill switching in the virtual scene.

The terminal device 400 may further implement, by running a computer program, the virtual scene interaction processing method. For example, the computer program may be a native program or a software module in an operating system; may be a native application (APP), that is, a program that needs to be installed in an operating system to run, for example, an open world game APP (that is, the foregoing client 410); may be a mini program, that is, a program that only needs to be downloaded into a browser environment to run; or may be a game mini program that can be embedded into any APP. In summary, the computer program may be an application, a module, or a plug-in in any form.

For example, the computer program may be an application program. In actual implementation, the terminal device 400 may install and run an application program that supports a virtual scene. The application program may be any one of an open world game, a first-person shooting game (FPS), a third-person shooting game, a virtual reality application program, a three-dimensional map program, a card strategy game, a sports game, a three-dimensional game, or a multiplayer shooter survival game. The player may operate a virtual object located in the virtual scene by using the terminal device 400 to perform an activity, and the activity may include but is not limited to: at least one of adjusting a body posture, crawling, walking, running, riding, jumping, driving, picking, shooting, attacking, throwing, and constructing a virtual building. For example, the virtual character may be a virtual person, such as a simulated person role or an animated person role.

The one or more aspects described herein may be implemented by a cloud technology. The cloud technology may be a hosting technology that unifies a series of resources such as hardware, software, and networks in a wide area network or a local area network to implement computing, storage, processing, and sharing of data.

The cloud technology is a general term of a network technology, an information technology, an integration technology, a management platform technology, and an application technology that are applied based on a cloud computing business model. The cloud technology may form a resource pool and be used as required, and is flexible and convenient. The cloud computing technology will become an important support. A background service of a technical network system requires a large amount of computing and storage resources.

For example, the server 200 in FIG. 1 may be an independent physical server, or may be a server cluster or a distributed system formed by a plurality of physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. The terminal device 400 may be a smartphone, a tablet computer, a notebook computer, a desktop computer, a smart sound box, a smart watch, an in-vehicle terminal, a virtual reality device, an augmented reality device, or the like, but is not limited thereto. The terminal device 400 and the server 200 may be directly or indirectly connected in a wired or wireless communication protocol.

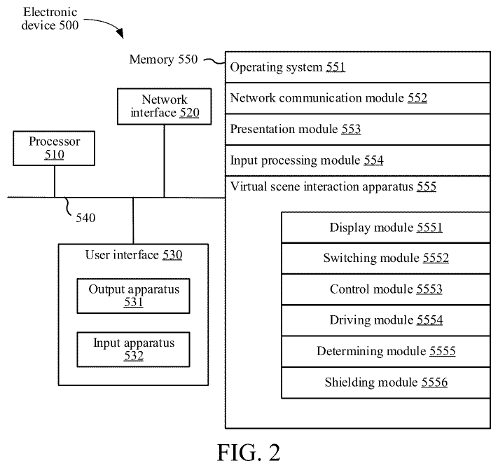

A structure of the electronic device provided in the one or more aspects described herein is described below. An example is used in which the electronic device is a terminal device. FIG. 2 is an example of a schematic structural diagram of an electronic device 500 according to one or more aspects described herein. The electronic device 500 shown in FIG. 2 includes: at least one processor 510, a memory 550, at least one network interface 520, and a user interface 530. All components in the electronic device 500 may be coupled together by using a bus system 540. The bus system 540 may be configured to implement connection and communication between the components. In addition to a data bus, the bus system 540 further may include a power bus, a control bus, and a status signal bus. However, for clear description, all types of buses in FIG. 2 are marked as the bus system 540.

The processor 510 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The user interface 530 may include one or more output apparatuses 531 that enable presentation of media content, including one or more speakers and/or one or more visual displays. The user interface 530 further may include one or more input apparatuses 532, including a user interface component that facilitates user input, such as a keyboard, a mouse, a microphone, a touchscreen display, a camera, another input button, and a control.

The memory 550 may be removable, non-removable, or a combination thereof. An exemplary hardware device includes a solid-state memory, a hard disk drive, an optical disk drive, and the like. The memory 550 may include one or more storage devices that are physically away (e.g., remotely located) from the processor 510.

The memory 550 may include a volatile memory or a non-volatile memory, or may include both a volatile memory and a non-volatile memory. The non-volatile memory may be a read-only memory (ROM), and the volatile memory may be a random access memory (RAM). The memory 550 may include any suitable type of memory.

The memory 550 may store data to support various operations, and examples of the data include programs, modules, and data structures, or subsets or supersets thereof, as illustrated below.

An operating system 551 may include system programs configured for processing various basic system services and executing hardware-related tasks, such as a framework layer, a kernel library layer, and a driver layer, and may be configured for implementing various basic services and processing hardware-based tasks.

A network communication module 552 may be configured to reach another computing device through one or more (wired or wireless) network interfaces 520. An example of the network interface 520 may include: Bluetooth, wireless compatibility authentication (Wi-Fi), universal serial bus (USB), and the like.

A presentation module 553 may be configured to enable presentation of information via one or more output apparatuses 531 (for example, a display and a speaker) associated with the user interface 530 (for example, a user interface for operating a peripheral device and displaying content and information).

An input processing module 554 may be configured to detect one or more user inputs or interactions from one of one or more input devices 532 and translate a detected input or interaction.

The apparatus may be implemented in a software manner. FIG. 2 shows an example of a virtual scene interaction apparatus 555 stored in the memory 550, which may be software in a form of a program, a plug-in, or the like, and may include the following software modules: a display module 5551, a switching module 5552, a control module 5553, a drive module 5554, a determining module 5555, and a shielding module 5556, which are logical modules. Therefore, any combination or further division may be performed according to an implemented function. For ease of expression, all the foregoing modules are shown in FIG. 2. However, the virtual scene interaction apparatus 555 may include implementations that may include only the display module 5551, the switching module 5552, and the control module 5553. Functions of the modules are described in the following.

The following describes the virtual scene interaction method.

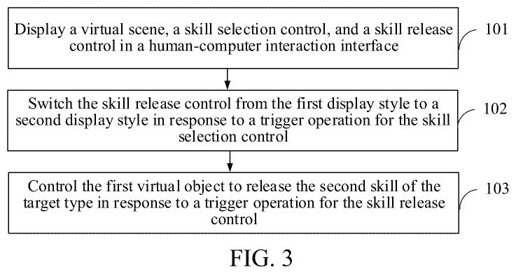

FIG. 3 is an example of a schematic flowchart of a virtual scene interaction method according to one or more aspects described herein, and operations shown in FIG. 3 are combined for description.

The method shown in FIG. 3 may be performed by various forms of computer programs run by the terminal device, not limited to the client, and for example, may alternatively be the operating system, the software module, the script, and the mini program described above. Therefore, the following examples of the client are not to be considered as limited. In addition, for ease of description, the terminal device and the client running on the terminal device are not specifically distinguished in the following.

Operation 101: Display a virtual scene, a skill selection control, and a skill release control in a human-computer interaction interface.

Herein, the virtual scene may include a first virtual object (for example, a game character A controlled by a current player), and the skill release control may be in a first display style by default. The first display style may represent that the skill release control is currently associated with a first skill (for example, a prop throwing skill).

In addition to the first virtual object controlled by the current player, another virtual object may further be displayed in the virtual scene. For example, at least one second virtual object controlled by a robot program or another player may be displayed, and the at least one second virtual object and the first virtual object may belong to the same virtual camp or different virtual camps.

A client (for example, an open world game APP) supporting the virtual scene may be installed on the terminal device. When a user opens the client installed on the terminal device (for example, the terminal device receives a tap operation performed by the user on an icon corresponding to the open world game APP presented on a desktop), and the terminal device runs the client, the virtual scene, the skill selection control (for example, a magic selection button), and the skill release control (for example, a sprite and a prop throwing button) that are in the first display style may be displayed on the human-computer interaction interface of the client. The virtual scene may include the first virtual object.

The virtual scene may be displayed on the human-computer interaction interface of the client at a first-person perspective (for example, the user plays a virtual object in a game at a perspective of the user). Alternatively, the virtual scene may be displayed at a third-person perspective (for example, the user follows a virtual object in the game to play the game); or the virtual scene may be displayed at a top-down perspective. The foregoing different viewing angles may be randomly switched.

As an example, the first virtual object may be an object controlled by a current user in a game. Certainly, the virtual scene may further include another virtual object, for example, a second virtual object that may be controlled by another user or controlled by a robot. The virtual object may be grouped into any one of a plurality of camps, there may be an enemy relationship or a cooperative relationship between camps, and the camps in the virtual scene may include one or all of the foregoing relationships.

Using displaying the virtual scene at the first-person perspective as an example, displaying the virtual scene on the human-computer interaction interface may include: A field of view region of the first virtual object may be determined according to a viewing location and a field angle of the first virtual object in the complete virtual scene, and a part of the virtual scene located in the field of view region in the complete virtual scene may be presented. That is, the displayed virtual scene may be a part of the virtual scene relative to a panoramic virtual scene. Because the first-person perspective is a viewing perspective that can most impact the user, immersive perception of the user being immersive in an operation process can be implemented.

Using displaying the virtual scene at the top-down perspective as an example, displaying the virtual scene on the human-computer interaction interface may include: in response to a zoom operation for the panoramic virtual scene, a part of the virtual scene corresponding to the zoom operation may be presented on the human-computer interaction interface. That is, the displayed virtual scene may be a part of the virtual scene relative to the panoramic virtual scene. In this way, operability of the user during the operation process can be improved, thereby improving efficiency of human-computer interaction.

Operation 102: Switch the skill release control from the first display style to a second display style in response to a trigger operation for the skill selection control.

Herein, the second display style represents that the skill release control may be currently associated with a second skill (for example, a magic skill, where the magic skill is a special skill in the game, the player may control a game character to interact with the game world by using the magic skill; for example, the player may interact with a terrain, an asset, or the like in the virtual scene to some extent by using the magic skill; for example, create or change a terrain in the virtual scene, or create a virtual wind field in the virtual scene). In addition, the second display style may be different from the first display style. For example, when the skill release control is in the first display style, the skill release control may include a material (for example, an icon or a name of the first skill) corresponding to the first skill. For example, the skill release control in the first display style may be represented by using the icon of the first skill, to remind the player that the skill release control is currently configured for releasing the first skill. When the skill release control is in the second display style, the skill release control may include a material corresponding to the second skill (for example, an icon or a name of the second skill). For example, the skill release control in the second display style may be represented by using the icon of the second skill, to remind the player that the skill release control is currently configured for releasing the second skill. In addition, the second skill may include a plurality of types (for example, including star magic and wind field magic). The skill selection control may be configured to select a target type from the plurality of types.

The skill selection control may be in a disabled state (that is, an unselected state) by default. The disabled state represents that the second skill is in an inactive state (in this state, the first virtual object cannot release the second skill). Therefore, in response to a trigger operation for the skill selection control, the following processing may be further performed: The skill selection control may be switched from the disabled state to an enabled state, where the enabled state represents that the second skill is in an active state (that is, a ready-to-use state, and in this state, the first virtual object may release the second skill).

When the skill selection control is switched from the disabled state to the enabled state, a display mode (for example, a display effect parameter of a material) of the skill selection control may change (but a type of the material does not change). For example, when the skill selection control is switched from the disabled state to the enabled state, the skill selection control may be displayed with highlighting or flashing.

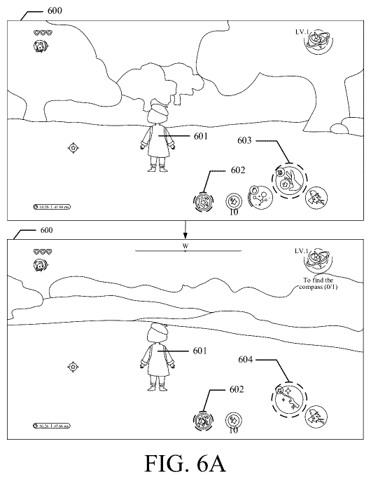

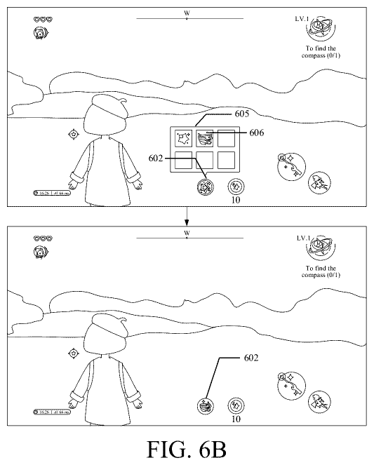

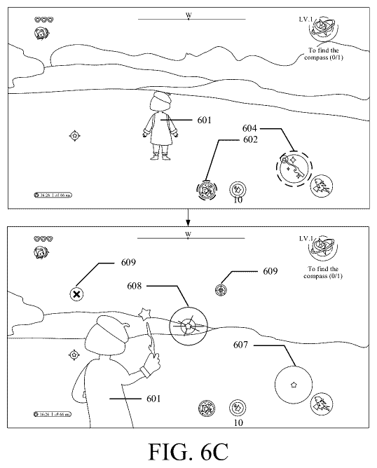

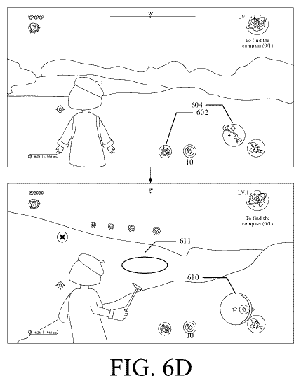

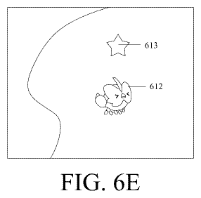

For example, a scenario in which the second skill is a magic skill is used. FIG. 6A is an example of a schematic diagram of an application scenario of a virtual scene interaction method according to one or more aspects described herein. As shown in FIG. 6A, a first virtual object 601 (for example, a game character A controlled by a current player), a skill selection control 602 (for example, a magic selection button in an unselected state) in a disabled state, and a sprite and prop throwing button 603 (that is, a skill release control in a first display style; in this case, the skill release control is associated with a prop throwing skill) may be displayed in a virtual scene 600 at a third-person perspective. When a tap operation of the player for the skill selection control 602 is received, the skill selection control 602 may be switched to an enabled state (for example, displayed with highlighting, to represent that the skill selection control 602 is currently in a selected state), and the sprite and prop throwing button 603 may be switched to a magic release button 604 (that is, a skill release control in a second display style; in this case, the skill release control is associated with a magic skill).

The skill selection control may be always displayed on the human-computer interaction interface, or may be displayed on the human-computer interaction interface only for a period of time. For example, after the skill release control is switched from the first display style to the second display style, display of the skill selection control may be canceled on the human-computer interaction interface. A display manner of the skill selection control is not specifically limited.

The target type may be a first type selected by default from the plurality of types, the default display style of the skill selection control may be a third display style, the third display style may represent that the skill selection control is currently associated with a second skill of the first type, and the first type may include one of the following: a type selected last time and/or a type selected for a largest quantity of times. For example, a material corresponding to the second skill of the first type (for example, an icon or a name corresponding to the second skill of the first type) may be configured for representing the skill selection control in the third display style. For example, using an example in which the second skill of the first type is star magic, an icon of star magic may be configured for representing the skill selection control in the third display style, to represent that the currently selected magic type is star magic. That is, when the selected magic type is star magic, the icon of the star magic may be used as a display style of the skill selection control.

The target type may alternatively be a second type manually selected by using the skill selection control, and after the skill selection control is switched to the enabled state, the following processing may further be performed: displaying a plurality of types of second skills in response to a trigger operation (for example, a tap operation or a long press operation) for the skill selection control in the enabled state; and switching the skill selection control to a fourth display style in response to that the second type in the plurality of types is selected, the fourth display style representing that the skill selection control is currently associated with the second skill of the second type. For example, a material corresponding to the second skill of the second type (for example, an icon or a name of the second skill of the second type) may be configured for representing the skill selection control in a fourth display style. For example, the second skill of the second type may be wind field magic, assuming that a previously selected magic type is star magic (that is, the current icon of the skill selection control is the icon corresponding to star magic), the skill selection control may be switched from the icon corresponding to star magic to the icon corresponding to wind field magic (that is, the fourth display style), to represent that the currently selected magic type is wind field magic.

For example, the second skill may be a magic skill. FIG. 6B is an example of a schematic diagram of an application scenario of a virtual scene interaction method according to one or more aspects described herein. As shown in FIG. 6B, when a long press operation performed by a player on the skill selection control 602 (for example, a magic selection button in a selected state) in the enabled state is received, a magic selection box 605 may be displayed. A plurality of magics are displayed in the magic selection box 605 for the player to select. When a tap operation performed by the player on wind field magic 606 displayed in the magic selection box 605 is received, the skill selection control 602 may be switched from the third display style (for example, the icon corresponding to star magic) to the fourth display style (for example, the icon corresponding to wind field magic). Therefore, it is convenient for the player to perform magic type switching.

Operation 103: Control the first virtual object to release the second skill of the target type in response to a trigger operation for the skill release control.

Herein, the second skill of the target type may have a plurality of effects, and a corresponding effect may be applied according to an object with which the second skill of the target type interacts. That is, effects applied by the second skill of the target type may be different for different interaction objects.

The second skill (for example, star magic) of the target type may be configured for driving the first virtual prop (for example, a virtual star) to autonomously move in the virtual scene according to a specified direction, and apply a corresponding effect to an object colliding with the first virtual prop. A type of the trigger operation may include a tap operation, and the foregoing operation 103 may be implemented in the following manner: controlling the first virtual object to release the second skill of the target type towards a first direction in response to the tap operation for the skill release control, to drive a first virtual prop to autonomously move along the first direction, and to apply a corresponding effect to an object colliding with the first virtual prop, the first direction being a current orientation of the first virtual object.

For example, the second skill of the target type may be star magic. Then, the corresponding first virtual prop may be a virtual star. When a tap operation performed by the player on the skill release control (for example, the magic release button) is received, the first virtual object may be controlled to directly release the star magic towards a direction (that is, a current orientation of the first virtual object) that a screen of the player faces, to drive the virtual star to autonomously move along the direction, and to apply a corresponding action to an object colliding with the virtual star.

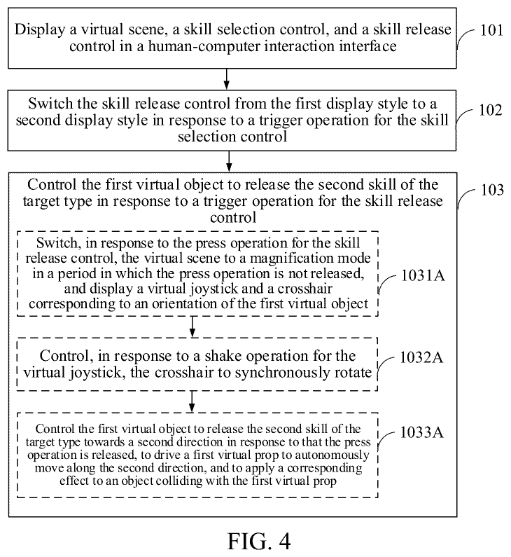

Still using the foregoing example, the type of the trigger operation may further include a press operation. In this case, operation 103 shown in FIG. 3 may be implemented by using operation 1031A to operation 1033A shown in FIG. 4, and description is given with reference to operations shown in FIG. 4.

Operation 1031A: Switch, in response to the press operation for the skill release control, the virtual scene to a magnification mode in a period in which the press operation is not released, and display a virtual joystick and a crosshair corresponding to an orientation of the first virtual object.

Using an example in which the second skill of the target type is star magic, when a long press operation performed by the player on the skill release control (for example, the magic release button) is received, a lens of a virtual camera in the virtual scene may be controlled to zoom in (that is, the virtual scene is switched to a zoom-in mode, to facilitate aiming by the player), to enter a “magic aiming” state, the virtual joystick may be displayed at a lower right corner of the screen, and the crosshair corresponding to the orientation of the first virtual object (for example, the game character A) may be displayed. For example, the crosshair may be displayed in front of the orientation of the game character A.

Operation 1032A: Control, in response to a shake operation for the virtual joystick, the crosshair to synchronously rotate.

Using the foregoing example, after the virtual joystick is displayed at the lower right corner of the screen, the player may rotate the screen by using the displayed virtual joystick, to perform magic aiming.

Operation 1033A: Control the first virtual object to release the second skill of the target type towards a second direction in response to that the press operation is released, to drive a first virtual prop to autonomously move along the second direction, and to apply a corresponding effect to an object colliding with the first virtual prop.

Herein, the second direction may be a direction corresponding to the crosshair after the rotation, that is, a direction pointing from the first virtual object to the crosshair after the rotation.

Using an example in which the second skill of the target type is star magic, when it is detected that the player releases the skill release control (for example, the magic release button), the first virtual object may be controlled to release star magic towards the direction corresponding to the crosshair after the rotation, to drive the virtual star to autonomously move along the direction, and to apply a corresponding effect to an object colliding with the virtual star.

For example, the applying a corresponding effect to an object colliding with the first virtual prop may be implemented in the following manner: performing at least one of the following processing: knocking down a collided second virtual object (for example, when the virtual star collides with a wild sprite in the virtual scene, the wild sprite may be knocked down and actions thereof are interrupted); displaying a collision identifier on a collided third virtual object, to increase a capture probability of the first virtual object for the third virtual object (for example, a sprite hit by star magic is attached with a star mark at the top of the head, and in this state, a success rate of the player using a sprite ball to capture the sprite is increased); destroying a collided virtual object (for example, when star magic collides with some loose rocks in the virtual scene, the rocks may be broken down, thereby facilitating the player to obtain a prop buried under the rocks); and/or activating a mission or a mechanism associated with a particular collided interactive object (for example, star magic may interact with some customized interaction objects in the virtual scene, to activate players associated with the interaction objects). That is, effects applied by the second skill of the target type may be different for different objects.

In response to a press operation for the skill release control, the following processing may further be performed: controlling the second skill of the target type to enter a charge state, so that at least one of prominence of the first virtual prop (for example, a virtual star) and an influence range of the first virtual prop increases as a charge level increases (for example, controlling a volume of the virtual star to continuously increase, or controlling brightness of the virtual star to continuously increase), the charge level being positively correlated to duration of the press operation; and controlling, in response to that the press operation is released, the second skill of the target type to exit the charge state.

For example, the second skill of the target type may be star magic and star magic may be charged before being released. There may be a plurality of charge levels, for example, the charge levels may be divided into three levels. A longer time in which the player presses the skill release control (that is, a longer charging time) may indicate a higher final charge level, correspondingly, a larger volume of the virtual star (or brightness of the virtual star may be gradually enhanced), and a larger exploding range of the virtual star after the virtual star lands. For example, for some rocks that are in the virtual scene and whose stiffness degree is greater than a stiffness degree threshold, the player may need to charge star magic, so that a released virtual star can break the rocks. That is, because energy of the virtual star released by the player by tapping is insufficient, the player cannot break the rocks.

When the second skill of the target type is in the charge state, a status value of the first virtual object may be continuously consumed, and when the second skill of the target type is controlled to enter the charge state, the following processing may further be performed: displaying a status progress control in the human-computer interaction interface (for example, including a status bar control or a status ring control), progress of the status progress control (for example, a length of the status bar control) continuously decreasing as the duration of the press operation increases, where the progress of the status progress control may be configured for representing a remaining status value of the first virtual object, that is, shorter progress of the status progress control represents a smaller remaining status value of the first virtual object.

For example, when the second skill of the target type enters the charge state, the status value of the first virtual object (for example, a stamina value) may be continuously consumed. When the remaining status value of the first virtual object is less than a status value threshold (for example, the stamina value of the player is insufficient), charging may be paused. For example, when stamina of a game character controlled by the player is insufficient, the second skill of the target type may automatically exit the charge state.

In an example, the second skill of the target type may be star magic. FIG. 6C is an example of a schematic diagram of an application scenario of a virtual scene interaction method according to one or more aspects described herein. As shown in FIG. 6C, when star magic is selected (in this case, the display style of the skill selection control 602 is the icon of star magic), when a long press operation of the player on the skill release control 604 (for example, the magic release button) is received, a virtual joystick 607 and a magic crosshair 608 corresponding to an orientation of the first virtual object 601 may be displayed at the lower right corner of the screen. In this case, the player may rotate the screen by using the virtual joystick 607 to perform magic aiming. When it is detected that the player releases the skill release control 607, the first virtual object 601 may be controlled to release star magic along the direction of magic crosshair 608. In addition, a status bar control (for example, a stamina gauge 609) of the first virtual object 601 may be further displayed in the virtual scene, and a length of the stamina bar in the stamina gauge 609 may become shorter as the duration of the press operation increases, indicating that the stamina value of the game character controlled by the player decreases, thereby facilitating the player to learn of the current stamina value of the game character.

During driving the first virtual prop to autonomously move along the first direction or the second direction, the following processing may further be performed: driving the first virtual prop to bounce when encountering a ground or an obstacle, bounce for a specified quantity of times (for example, 4) at most, and explode in the last bounce.

For example, the driving the first virtual prop to bounce when encountering a ground or an obstacle may be implemented in the following manner: performing the following processing when the first virtual prop encounters the ground or an obstacle: determining a bounce direction of the first virtual prop that conforms to a physical rule in a real world, or limiting movement of the first virtual prop to a plane (that is, motion of the first virtual prop may be changed from three dimensions to two dimensions, so as to be more predictive) with the bounce direction being a forward direction or a backward direction along the plane, the plane being a plane formed by a throwing direction and an anti-gravity direction of the first virtual prop; determining an elevation angle and a speed of bouncing of the first virtual prop, the elevation angle and the speed being positively correlated to a charge level (that is, a higher charge level may indicate a larger elevation angle and speed); and driving the first virtual prop to bounce according to the bounce direction, the elevation angle, and the speed. In this way, it can be ensured that a motion trajectory of the first virtual prop is more easily predicted, and a hit rate of hitting a target object (such as a wild sprite, a tree, or a rock) in the virtual scene by using the first virtual prop is increased, thereby improving human-computer interaction efficiency.

In a process of driving the first virtual prop to bounce, at least one of the following processing may further be performed: multiplying displacement of the first virtual prop in each frame by a specified adjustment coefficient (for example, a multiplication result of the displacement and the adjustment coefficient may be used as final displacement of the first virtual prop, to control a movement capability of the first virtual prop as a whole), so that a height of the first virtual prop during each bounce keeps the same; and obtaining a deceleration coefficient that conforms to a motion law in the real world, and attenuating a flight speed of the first virtual prop in each frame based on the obtained deceleration coefficient. For example, the flight speed and the deceleration coefficient may be multiplied, and a multiplication result may be used as a final flight speed of the first virtual object, to simulate an actual situation in reality, so that a motion trajectory of the first virtual prop better conforms to a real situation, and the first virtual prop is prevented from being excessively fast, which causes the player not to clearly see the motion trajectory.

The second skill of the target type (for example, wind field magic) may further be configured for creating a virtual wind field at a specified location in the virtual scene, and applying a corresponding effect to an object entering the virtual wind field. The type of the trigger operation may include a tap operation, and operation 103 may further be implemented in the following manner: controlling, in response to the tap operation for the skill release control, the first virtual object to release the second skill of the target type at a first location, to create a virtual wind field at the first location, and apply a corresponding effect to an object entering the virtual wind field, the first location being a location of the first virtual object.

For example, the second skill of the target type may be wind field magic. When a tap operation performed by the player on the skill release control (for example, the magic release button) is received, a virtual wind field may be directly created at a location of the player (that is, a location of the first virtual object controlled by the player), and a corresponding effect may be applied to an object entering the virtual wind field, for example, a height of a virtual vehicle entering the virtual wind field may be increased, so that the virtual vehicle can fly farther.

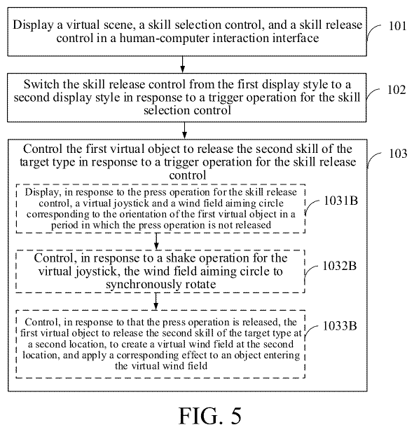

Still using the foregoing example, the type of the trigger operation may be a press operation. In this case, operation 103 shown in FIG. 3 may be implemented by using operation 1031B to operation 1033B shown in FIG. 5, and description is given with reference to operations shown in FIG. 5.

Operation 1031B: Display, in response to the press operation for the skill release control, a virtual joystick and a wind field aiming circle corresponding to the orientation of the first virtual object in a period in which the press operation is not released.

Using an example in which the second skill of the target type is wind field magic, when a long press operation performed by the player on the skill release control (for example, the magic release button) is received, an aiming and releasing state of wind field magic may be entered. In this case, a virtual joystick may be displayed at the lower right corner of the screen, and a wind field aiming circle corresponding to the orientation of the first virtual object (for example, the game character A) may be displayed. For example, the wind field aiming circle may be displayed in front of the orientation of the game character A.

Operation 1032B: Control, in response to a shake operation for the virtual joystick, the wind field aiming circle to synchronously rotate.

Still using the foregoing example, the player may rotate the screen by using the virtual joystick displayed at the lower right corner of the screen, to perform aiming of wind field magic.

Operation 1033B: Control, in response to that the press operation is released, the first virtual object to release the second skill of the target type at a second location, to create a virtual wind field at the second location, and apply a corresponding effect to an object entering the virtual wind field.

Herein, the second location may be a location of the wind field aiming circle after the rotation.

When it is detected that the player loosens the skill release control, a wind field aiming circle (that is, the second location, indicating a location at which the virtual wind field is to be created) may be displayed in the virtual scene, and the first virtual object may be controlled to release wind field magic at the wind field aiming circle, to create the virtual wind field at the wind field aiming circle, and apply a corresponding effect to an object entering the virtual wind field.

For example, the second skill of the target type may be a magic skill. FIG. 6D is an example of a schematic diagram of an application scenario of a virtual scene interaction method according to one or more aspects described herein. As shown in FIG. 6D, when wind field magic is selected (in this case, the display style of the skill selection control 602 is an icon of wind field magic), when a long press operation of the player on the skill release control 604 (for example, the magic release button) is received, a virtual joystick 610 and a wind field aiming circle 611 corresponding to the orientation of the first virtual object (for example, the game character A) may be displayed at the lower right corner of the screen. The player may rotate the screen by using the virtual joystick 610, to perform aiming of wind field magic. When it is detected that the player loosens the skill release control 604, the virtual wind field may be created at the rotated wind field aiming circle 611.

The applying a corresponding effect to an object entering the virtual wind field may be implemented in the following manner: performing at least one of the following processing: increasing a height of a virtual vehicle entering the virtual wind field (for example, when the player uses a flight vehicle to enter a range of the wind field magic, the flight vehicle may be affected by the wind field to quickly increase the height); increasing a height of a virtual throwable object entering the virtual wind field (for example, when the player throws a grunting ball, a prop, a virtual star released by using star magic, or the like, and it passes through the virtual wind field in a flight process, it may be also affected by the virtual wind field to increase by a specific distance, and finally flies farther away); and activating a mission or a mechanism associated with a particular interactive object entering the virtual wind field (for example, a magic windmill may be blown through the virtual wind field, to activate a mechanism associated with the magic windmill).

Before the first virtual object is controlled to release the second skill of the target type at the second location, the second location (that is, the creation point of the virtual wind field) may further be determined in the following manner: transmitting, by using the first virtual object (a location of an eye of the first virtual object) as a start point, a detection ray along an orientation of the first virtual object after the rotation, to obtain a collision point or a farthest point, and pasting the collision point or the farthest point on a terrain; constructing a spherical matrix by using the collision point or the farthest point as a lower-side center of the spherical matrix; calculating a ray collision rate of the spherical matrix; using the collision point or the farthest point as the second location when the collision rate is less than a collision rate threshold (for example, 60%); or iteratively performing the following processing when the collision rate is greater than or equal to the collision rate threshold: obtaining a new point along a direction approaching the first virtual object; constructing a spherical matrix by using the new point as a lower-side center of the spherical matrix, and calculating a ray collision rate of the spherical matrix; and using the new point as the second location when the collision rate is less than the collision rate threshold. In this way, it can be ensured that the virtual wind field is created in a relatively flat and open region in the virtual scene, so as to avoid that the wind in the virtual wind field is blocked by an obstacle, and cannot apply a corresponding effect to an object entering the virtual wind field.

When the virtual wind field is located at a slope in the virtual scene, before the increasing the height of the virtual vehicle or the virtual throwable object entering the virtual wind field, the following processing may further be performed: using a projection point of the virtual vehicle or the virtual throwable object at a plane of the virtual wind field close to the ground as a detection start point; controlling the detection start point to be offset upwards by a distance corresponding to a gradient value of the slope, the distance being positively correlated to the gradient value; transmitting a detection ray to the virtual vehicle or the virtual throwable object from the detection start point after the offset; and determining, when a detection result indicates that there is no blockage, to increase the height of the virtual vehicle or the virtual throwable object entering the virtual scene; or determining, when a detection result indicates that there is a blockage, not to increase the height of the virtual vehicle or the virtual throwable object entering the virtual scene. In this way, wind blocking logic of an obstacle in the real world can be simulated, thereby further improving game experience of the player.

After creating a virtual wind field at the second location when there is a terrain object at the second location, the following processing may further be performed: shielding the terrain object from blocking wind in the virtual wind field in a process of controlling the wind in the virtual wind field to move upwards from the ground. In this way, the virtual wind field may be formed on the slope, to avoid that the wind in the virtual wind field is blocked by the terrain object, causing that a corresponding effect cannot be applied to an object entering the virtual wind field.

After creating a virtual wind field at the second location when there is a non-terrain object at the second location, at least one of the following processing may further be performed: shielding the non-terrain object from blocking wind in the virtual wind field in a process of controlling the wind in the virtual wind field to move upwards from the ground when the non-terrain object is a wind-permeable object; and determining, when the non-terrain object is a non-wind-permeable object in the process of controlling the wind in the virtual wind field to move upwards from the ground, that at least some wind in the virtual wind field is blocked by the non-terrain object. In this way, the wind in the virtual wind field may be blocked by an obstacle in the virtual scene, thereby simulating wind blocking logic in a real environment.

In the virtual scene interaction method, through linkage between a skill selection control and a skill release control, a player can quickly switch to a second skill that needs to be released, and can select, by using the skill selection control, a second skill of a target type from a plurality of types of second skills to be released. In this way, efficiency of skill switching in a virtual scene is improved. Further, a plurality of effects may be integrated into the second skill, so that the second skill can have a plurality of effects. In this way, under the same operation method, the player can apply different effects for different objects by changing an application strategy, thereby improving efficiency of human-computer interaction in the virtual scene, and further improving game experience of the player. In addition, compared with a solution provided in a related technology, operation operations are simplified, and resource overheads of a terminal device can be reduced.

The following uses an open world game as an example to describe an example application of the one or more aspects described herein in an actual application scenario.

One or more aspects described herein provides a virtual scene interaction method, applied to an open world game. A player may interact with a game world by using a magic skill (corresponding to the foregoing second skill, which is referred to as magic for short below), and the same magic has a plurality of functions. For example, under the same operation method, the player may implement a plurality of functions such as scene interaction, movement capacity improvement, and sprite capturing assistance by using changes in an application strategy.

The following additionally describes the virtual scene interaction method.

FIG. 6A is an example of a schematic diagram of an application scenario of a virtual scene interaction method according to one or more aspects described herein. As shown in FIG. 6A, a game character 601 (corresponding to the foregoing first virtual object) controlled by a current player may be displayed in a virtual scene 600. A magic selection button 602 (corresponding to the foregoing skill selection control) and a sprite and prop throwing button 603 (corresponding to the foregoing skill release control in the first display style) may be further displayed in the virtual scene 600. When a tap operation of the player on the magic selection button 602 is received, a magic release preparation state may be entered. In this case, the sprite and prop throwing button 603 at the lower right corner of the screen may be switched to the magic release button 604 (corresponding to the foregoing skill release control in the second display style).

When a tap operation of the player on the magic selection button 602 is received, the magic selection button 602 may switch from an unselected state to a selected state. For example, when a tap operation of the player on the magic selection button 602 is received, the magic selection button 602 may be displayed in a highlighting manner, to represent that the magic selection button 602 is currently in a selected state.

The player may further switch magics. For example, FIG. 6B is an example of a schematic diagram of an application scenario of a virtual scene interaction method according to one or more aspects described herein. As shown in FIG. 6B, when a long press operation performed by the player on the magic selection button 602 in a selected state is received, a magic selection box 605 may pop up, and a plurality of magics may be displayed in the magic selection box 605 for the player to select. After the player selects a magic to be released in the magic selection box 605, an icon of the magic selection button 602 may also change to a style corresponding to the magic. For example, assuming that the player selects wind field magic 606 in the magic selection box 605, an icon of the magic selection button 606 may be switched from a style corresponding to star magic to a style corresponding to wind field magic.

When the player selects the star magic, the player quickly taps the magic release button, to directly release the star magic towards a direction of the screen of the player. In addition, as shown in FIG. 6C, when a tap operation of the player on the magic release button 604 is received, a “magic aiming” state is entered. In this case, a virtual joystick 607 may be displayed at the lower right corner of the screen, and the player may rotate the screen by using the virtual joystick 607 to perform magic aiming. When it is detected that the player releases the magic release button 604, the game character 601 may be controlled to release the star magic towards a direction of a magic star 608. In addition, a stamina gauge 609 may be further displayed in the virtual scene. When the player long presses the magic release button 604, the star magic may enter a charge state, and the stamina value of the game character 601 may be continuously consumed in a charging process.

When wind field magic is selected, and the player quickly taps the magic release button, a virtual wind field may be directly created at the location of the game character controlled by the player. In addition, as shown in FIG. 6D, when a long press operation of the player on the magic release button 604 is received, an aiming release state of the wind field may be entered. In this case, a white circle 611 (that is, a wind field aiming circle) may appear in the scene, stick to the ground, and indicate a location (corresponding to the foregoing second location) at which the virtual wind field is to be created.

Functions and rules of star magic continue to be described below.

Star magic may perform charging before being released. There may be a plurality of sections (for example, three sections) of charging, and stamina of the game character controlled by the player is continuously consumed in the charging process. When star magic is quickly released (for example, the player quickly taps the magic release button), charging may not be performed. Charging may be started only when the player long presses the magic release button to enter an aiming spell-casting state. A longer time in this state may indicate a higher quantity (or referred to as a level) of accumulated energy sections. In addition, during charging, if stamina of the game character controlled by the player is insufficient (for example, a stamina value is less than a specified stamina value threshold), charging may be paused. A larger quantity of charging sections may indicate a larger volume of the star (the collision range is correspondingly enlarged), and a larger explosion range after the star lands.

In addition, after the star magic is released, bounce occurs when the star magic encounters the ground or an obstacle. For example, four bounces may be performed at most, and explosion occurs in the last bounce.

The star magic may have a plurality of functions. For example, the player may use the star magic to knock down a wild sprite in the game world and interrupt its actions. Certainly, the star magic may also be configured for improving the probability of capturing the sprite. For example, as shown in FIG. 6E, a sprite 612 hit by the star magic may be attached with a star mark 613 at the head. In this state, the probability of capturing the sprite by the player may be greatly increased. In addition, when star magic collides with a tree, a fruit on the tree or a sprite on the tree may be knocked off. When striking a relatively strong tree, the player first needs to charge the star magic. In addition, when the star magic hits some loosened rocks in the game world, the rocks may be broken up, thereby facilitating the player to obtain a prop buried under the rocks. For a large and relatively stiff stone, the player first needs to charge the star magic. Certainly, the player may further interact, by using the star magic, with some interactive objects customized in the scene, so as to activate playing methods associated with the interactive objects.

Functions and rules of wind field magic continue to be described below.

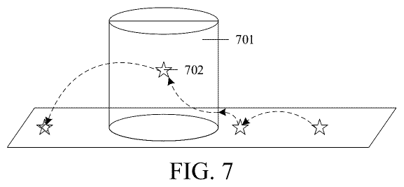

Wind field magic may affect a movement capability of the player's vehicle. For example, when the player uses a flying vehicle and enters a range of the wind field magic, the player may be affected by the wind field to quickly increase the height. In addition, different flying vehicles have different performance in the wind field. For example, a winter X sparrow may rise at a constant speed in the wind field and eventually stay at the top of the wind field, whereas a dandelion may accelerate within the wind field and eventually be thrown out of the wind field due to inertia. In addition, the wind field magic may further affect a flight trajectory of a throwable object. For example, when the player throws an XX ball, a virtual prop, or releases the star magic, and it passes through the virtual wind field in a flight process, it may be affected by the virtual wind field to be elevated by a short distance, and finally it flies farther. As shown in FIG. 7, when the virtual star 702 passes through the virtual wind field 701 in the flight process, the virtual star may be affected by the virtual wind field 701 to be elevated by a short distance, and finally the virtual star 702 flies farther. In addition, the wind field magic may further interact with a magic component in a scene. Similar to the star magic, the virtual wind field may also interact with some customized interactive objects and activate playing methods associated with the customized interactive objects. For example, the virtual wind field may blow a magic windmill, to activate a mechanism.

The following continues to describe bounce logic of the star magic.

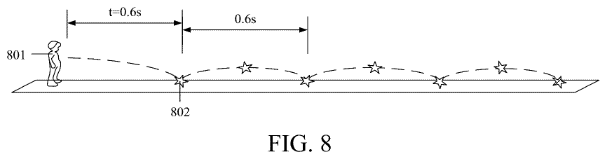

FIG. 8 is an example of a schematic principle diagram of a virtual scene interaction method according to one or more aspects described herein. As shown in FIG. 8, after a player controls a game character 801 to release star magic, to make movement of a virtual star easier to predict, in a process of bouncing for a plurality of sections, a virtual star 802 needs to maintain a similar height during each section, that is, each section of bounce can maintain a trajectory that relatively conforms to a physical rule, but seems to be easier to predict, and is smoother and more regular.

To achieve the effect shown in FIG. 8, the one or more aspects described herein provide the following several technical solutions:

First, if according to real physical rebound logic, when a rugged ground is encountered, kinetic energy of a virtual star quickly attenuates, and a direction of bounce is 360 degrees, it is easy that a motion trajectory of the virtual star becomes very chaotic due to some small obstacles.

For the foregoing technical problem, the one or more aspects described herein start from the following two perspectives. First, regarding the rebound direction, to ensure that the virtual star can move on the same plane regardless of the terrain it encounters, the trajectory of the virtual star may be constrained within a plane formed by the throwing direction and the upward direction. Through such constraints, the motion trajectory of the virtual star may be transformed from three-dimensional to two-dimensional, thereby making it more predictable. Second, regarding the problem of rebound speed and angle, the technical solution provided by the one or more aspects described herein involves projecting the direction calculated by the physical rebound onto the plane of the virtual star's motion after the virtual star lands. The newly calculated exit speed may then be amplified, for example, restored to the same kinetic energy as the initial throwing speed, thereby ensuring that each bounce has sufficient initial speed, just like the first bounce.

An angle range of the emergent angle may further be limited. For example, the angle range of the emergent angle may be limited to 30 degrees to 60 degrees, and an emergent angle outside this angle range may be rotated into this angle range and then emitted. In this way, a problem that the emergent angle is excessively large or excessively small can be avoided, thereby achieving controllability of a rebound direction.

When the initial speed of the virtual star is relatively small, a start point of a motion trajectory of the virtual star may be on the hand of the game character and look relatively normal, but a rebound start location after landing may be the ground. To implement a trajectory similar to that in the first time, more kinetic energy is needed. In terms of physics, the kinetic energy needs to come from gravitational energy. Therefore, the gravitational energy may be calculated by using a height difference between the initial point and the landing point of the virtual star, then the gravitational energy may be converted into kinetic energy in a proportion by using a configured coefficient, and may be added to total kinetic energy of bounce of the virtual star, so that the bounce of the virtual star on the ground may be as high as that in the first time.

To achieve an elegant curve for the virtual star's movement trajectory, such as |sin (x)|, the one or more aspects described herein can also limit the horizontal speed by reducing the proportion of gravitational potential energy converted into kinetic energy. Additionally, a minimum vertical speed for each bounce may be set. Based on the finally calculated bounce speed, the vertical speed may be increased to at least a level higher than the minimum vertical speed, thereby ensuring a minimum guaranteed height for each bounce and preventing the virtual star from skimming close to the ground like a stone skipping on water.

To achieve the effect shown in FIG. 8, the one or more aspects described herein can also divide the kinetic energy into two parts, namely horizontal and vertical. By ensuring that the horizontal and vertical kinetic energy remains constant, the effect of each bounce can be maintained at a relatively consistent level. For the vertical kinetic energy, gravitational potential energy can be introduced, converting gravitational potential energy into vertical kinetic energy at a specific ratio. This ensures that even when the initial vertical speed is almost zero, a relatively stable height can be maintained, thereby achieving predictable results.

In addition, the one or more aspects described herein also provide another technical solution in which the physical rules are only configured for calculating the horizontal direction of the bounce, or the motion of the virtual star is still confined to a plane, with the bounce direction limited to only forward and backward directions, or even restricted to just one direction. In addition, if the virtual star encounters an obstacle and cannot move forward, it may explode on the spot. Then, based on the charge level, the elevation angle and speed of the virtual star's bounce may be determined. That is, the elevation angle and speed of the virtual star's bounce may only be related to the charge level. This ensures that the behavior of the virtual star remains within a predictable range and is not significantly affected by the throwing angle or terrain, thereby avoiding unpredictability. For example, this approach can prevent the virtual star's behavior from becoming erratic in situations with significant height variations, such as when climbing a slope where the calculated vertical momentum might be downward, or when falling from a high cliff where the upward kinetic energy might be very large, causing the virtual star to bounce very high and making its landing point extremely difficult to predict.

The one or more aspects described herein may also incorporate some post-processing on top of the physical calculations, thereby making the motion trajectory of the virtual star more magical and enhancing the player's tactile experience. For example, the main adjustments may include the following two aspects: multiplying the displacement calculated for each frame of the virtual star by a coefficient, thereby controlling the overall mobility of the virtual star; simulating wind resistance, which may involve applying a decay to the speed calculated for each frame. The decay amount may be calculated as the current frame speed*DeltaTime*deceleration coefficient, where DeltaTime may represent the time value. For instance, for the first frame, DeltaTime can be set to 1, for the second frame, DeltaTime can be set to 2, and so on. In other words, the flight speed of the virtual star can be proportionally reduced to simulate real-world conditions, while also avoiding the issue of the virtual star's motion trajectory becoming unclear due to excessive speed.

Terrain blocking logic of the virtual wind field continues to be described below.

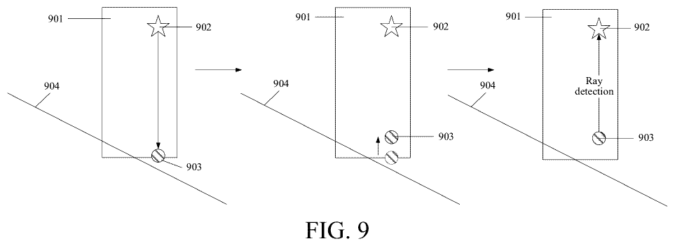

FIG. 9 is an example of a schematic principle diagram of a virtual scene interaction method according to one or more aspects described herein. As shown in FIG. 9, for a virtual object 902 entering a virtual wind field 901, a projection point of the virtual object 902 in a bottom plane of the virtual wind field 901 may be used as a detection start point 903, then the detection start point 903 may be offset upward by a particular distance according to a gradient value of a slope 904, where the offset may be positively correlated to the gradient value, and subsequently, ray detection from bottom to top may be performed between the offset detection start point 903 and the virtual object 902. If there is a blockage, it may be determined that the virtual object 902 is not affected by the virtual wind field 901. If there is no blockage, it may be determined that the virtual object 902 is affected by the virtual wind field 901, for example, the virtual object 902 rises by a distance due to the influence of the virtual wind field 901. In this way, the wind in the virtual wind field can be blocked by the obstacle in the virtual scene, thereby simulating real wind blocking logic.

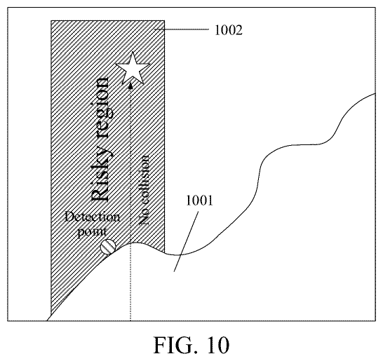

FIG. 10 is an example of a schematic principle diagram of a virtual scene interaction method according to one or more aspects described herein. As shown in FIG. 10, when a virtual wind field 1002 overlaps with a terrain object 1001, for the terrain object 1001, single-sided collision can filter collision from bottom to top. That is, a blocking effect of an overlapping part of the terrain object 1001 on a wind in the virtual wind field 1002 can be filtered, thereby achieving an effect of forming a virtual wind field on a slope.

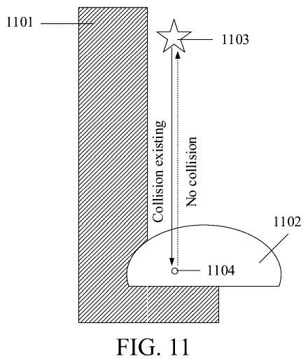

For a non-terrain object, a collision channel may be configured for filtering out an object that does not need to block the wind. In addition, as shown in FIG. 11, for another wind blocking object 1102, if a bottom region of the object 1102 overlaps a virtual wind field 1101, the wind field may still need to be blocked. Two-way rays may be configured for detection herein. For example, detection may be first performed from bottom to top and then from top to bottom. Only when there is no collision in both cases, it may be considered that there is no blockage. For example, a star 1103 shown in FIG. 11 may represent a virtual object entering the virtual wind field 1101, and a point 1104 may be a projection point of the star 1103. If the point 1104 is inside the object 1102, it may be considered that a part of wind in the virtual wind field 1101 is blocked by the object 1102. In this case, the star 1103 may not be affected by the virtual wind field 1101. Herein, the collision can be understood as an issue of single-sided model normals, meaning that the side facing the normal may have collisions, while the other side may not. In FIG. 11, the normal direction of object 1102 may be upward, so there is no collision from the point 1104 to the star 1103, but there may be a collision from the star 1103 to the point 1104.

The following continues to explain point selection logic for the virtual wind field.

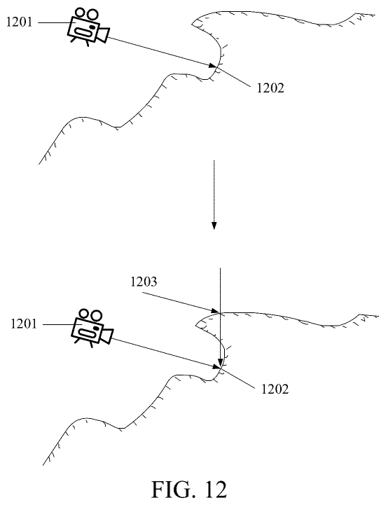

FIG. 12 is an example of a schematic principle diagram of a virtual scene interaction method according to one or more aspects described herein. As shown in FIG. 12, a detection ray may be first transmitted from a camera 1201, to obtain a terrain intersection point 1202. Next, a ground intersection point 1203 located above the terrain intersection point 1202 may be obtained, then whether a horizontal distance between a collision point (for example, the ground intersection point 1203) and a game character controlled by a player exceeds a maximum spell-casting radius (that is, a horizontal distance limitation) may be detected, whether a slope value exceeds a defined slope value threshold (to filter steep terrains) may be detected, and if the foregoing two conditions are not satisfied, a detection range may be narrowed, and the foregoing process may be repeated until a creation point of the virtual wind field is obtained. If the foregoing two conditions are satisfied, the collision point may be directly used as the creation point of the virtual wind field.

When the detection range is narrowed to the smallest, and a legal creation point is still not found, corresponding prompt information may be displayed on a human-computer interaction interface, to remind the player.

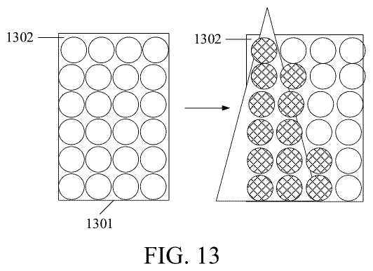

One or more aspects described herein further provide another technical solution. First, a detection ray may be transmitted forward along a direction of a camera, to obtain a collision point or a farthest point. In this way, it can prevent small components from blocking terrain intersection detection and also avoid the problem where large obstacles cause the collision point to be too high and exceed the picture when obtaining the ground intersection point. As shown in FIG. 13, using a collision point as an example, the collision point may be adhered to a terrain, and a spherical matrix 1302 may be constructed by using the collision point 1301 as the lower-side center of the spherical matrix 1302, to detect collision towards the front, and then a ray collision rate of the spherical matrix 1302 may be calculated (a ball filled with a shadow shown in FIG. 13 represents a collided ball), and if the collision rate is greater than a collision rate threshold (such as 60%), there may be a blockage; otherwise, there may be no blockage. If there is a blockage, the distance may be reduced along the direction of the game character controlled by the player, and the foregoing process may be repeated. If there is no blockage, the collision point 1301 may be directly used as the creation point of the virtual wind field. In this way, the player can release the wind field magic in a broad and flat region as much as possible, to avoid that the wind in the virtual wind field is blocked by an obstacle, and a corresponding effect cannot be generated.

In conclusion, the virtual scene interaction method provided in the one or more aspects described herein has at least the following beneficial effects: A single set of mechanisms enables a plurality of gameplay experiences, simplifying player operations while enhancing the depth of a single system. This provides players with the opportunity to explore emergent gameplay possibilities. And from a presentation perspective, it fulfills players' imagination of magical gameplay. Additionally, it offers excellent functional expandability.

The following continues to describe that implementation of a virtual scene interaction apparatus 555 provided in one or more aspects described herein, which may include an example structure of a software module. In some instances, as shown in FIG. 2, software modules stored in the virtual scene interaction apparatus 555 of the memory 550 may include: a display module 5551, a switching module 5552, and a control module 5553.

The display module 5551 may be configured to display a virtual scene, a skill selection control, and a skill release control in a human-computer interaction interface, the virtual scene including a first virtual object, the skill release control being in a first display style, and the first display style representing that the skill release control is currently associated with a first skill; the switching module 5552 may be configured to switch the skill release control from the first display style to a second display style in response to a trigger operation for the skill selection control, the second display style representing that the skill release control is currently associated with a second skill, the second skill including a plurality of types, and the skill selection control being configured for selecting one target type from the plurality of types; and the control module 5553 may be configured to control the first virtual object to release the second skill of the target type in response to a trigger operation for the skill release control.

The skill selection control may be in a disabled state by default, and the disabled state represents that the second skill is in an inactive state; and the switching module 5552 may be further configured to: in response to the trigger operation for the skill selection control, switch the skill selection control from the disabled state to an enabled state, the enabled state representing that the second skill is in an activate state.

The target type may be a first type selected by default from the plurality of types, a default display style of the skill selection control may be a third display style, the third display style represents that the skill selection control is currently associated with the second skill of the first type, and the first type includes one of the following: a type selected last time and a type selected for a largest quantity of times.

The target type may be a second type manually selected by using the skill selection control; and the display module may be is further configured to display a plurality of types of second skills in response to a trigger operation for the skill selection control in the enabled state; and the switching module 5552 may be further configured to: switch the skill selection control to a fourth display style in response to that the second type in the plurality of types is selected, the fourth display style representing that the skill selection control is currently associated with the second skill of the second type.

The type of the trigger operation may include a tap operation; and the control module 5553 may be further configured to control the first virtual object to release the second skill of the target type towards a first direction in response to the tap operation for the skill release control, to drive a first virtual prop to autonomously move along the first direction, and to apply a corresponding effect to an object colliding with the first virtual prop, the first direction being a current orientation of the first virtual object.

The type of trigger operation may include a press operation; the display module 5551 may be further configured to: switch, in response to the press operation for the skill release control, the virtual scene to a magnification mode in a period in which the press operation is not released, and display a virtual joystick and a crosshair corresponding to an orientation of the first virtual object; and the control module 5553 may be further configured to control, in response to a shake operation for the virtual joystick, the crosshair to synchronously rotate; and may be configured to control the first virtual object to release the second skill of the target type towards a second direction in response to that the press operation is released, to drive a first virtual prop to autonomously move along the second direction, and to apply a corresponding effect to an object colliding with the first virtual prop, the second direction being a direction corresponding to the crosshair after the rotation.

The control module 5553 may be further configured to: in response to a press operation for the skill release control, control the second skill of the target type to enter a charge state, so that at least one of prominence of the first virtual prop and an influence range of the first virtual prop increases as a charge level increases, the charge level being positively correlated to duration of the press operation; and may be configured to control, in response to that the press operation is released, the second skill of the target type to exit the charge state.

The display module 5551 may be further configured to: during the controlling the second skill of the target type by the control module 5553 to enter a charge state, display a status progress control in the human-computer interaction interface, progress of the status progress control continuously decreasing as the duration of the press operation increases, and the progress of the status progress control may be configured for representing a remaining status value of the first virtual object.

The control module 5553 may be further configured to perform at least one of the following processing: knocking down a collided second virtual object; displaying a collision identifier on a collided third virtual object, to increase a capture probability of the first virtual object for the collided third virtual object; destroying a collided virtual object; and activating a mission or a mechanism associated with a particular collided interactive object.

The virtual scene interaction apparatus 555 further includes a driving module 5554, and may be configured to: during driving the first virtual prop to autonomously move along the first direction or the second direction, drive the first virtual prop to bounce when encountering a ground or an obstacle, and bounce for a specified quantity of times at most.

The driving module 5554 may be further configured to perform the following processing when the first virtual prop encounters the ground or an obstacle: determining a bounce direction of the first virtual prop that conforms to a physical rule in a real world, or limiting movement of the first virtual prop to a plane with the bounce direction being a forward direction or a backward direction along the plane, the plane being a plane formed by a throwing direction and an anti-gravity direction of the first virtual prop; determining an elevation angle and a speed of bouncing of the first virtual prop, the elevation angle and the speed being positively correlated to a charge level; and driving the first virtual prop to bounce according to the bounce direction, the elevation angle, and the speed.

In a process of driving the first virtual prop to bounce, the driving module 5554 may be further configured to perform at least one of the following processing: multiplying displacement of the first virtual prop in each frame by a specified adjustment coefficient, so that a height of the first virtual prop during each bounce keeps the same; and obtaining a deceleration coefficient that conforms to a motion law in the real world, and attenuating a flight speed of the first virtual prop in each frame based on the deceleration coefficient.

The type of the trigger operation includes a tap operation; and the control module 5553 may be further configured to: control, in response to the tap operation for the skill release control, the first virtual object to release the second skill of the target type at a first location, to create a virtual wind field at the first location, and apply a corresponding effect to an object entering the virtual wind field, the first location being a location of the first virtual object.

The type of trigger operation includes a press operation; the display module 5551 may be further configured to: display, in response to the press operation for the skill release control, a virtual joystick and a wind field aiming circle corresponding to the orientation of the first virtual object in a period in which the press operation is not released; and the control module 5553 may be further configured to control, in response to a shake operation for the virtual joystick, the wind field aiming circle to synchronously rotate; and configured to control, in response to that the press operation is released, the first virtual object to release the second skill of the target type at a second location, to create a virtual wind field at the second location, and apply a corresponding effect to an object entering the virtual wind field, the second location being a location of the wind field aiming circle after the rotation.

The virtual scene interaction apparatus 555 further includes a determining module 5555, and may configured to: before the control module 5553 controls the first virtual object to release the second skill of the target type at the second location, determine the second location in the following manner: transmitting, by using the first virtual object as a start point, a detection ray along an orientation of the first virtual object after the rotation, to obtain a collision point or a farthest point, and pasting the collision point or the farthest point on a terrain; constructing a spherical matrix by using the collision point or the farthest point as a lower-side center of the spherical matrix; calculating a ray collision rate of the spherical matrix; using the collision point or the farthest point as the second location when the collision rate is less than a collision rate threshold; or iteratively performing the following processing when the collision rate is greater than or equal to the collision rate threshold: obtaining a new point along a direction approaching the first virtual object; constructing a spherical matrix by using the new point as a lower-side center of the spherical matrix, and calculating a ray collision rate of the spherical matrix; and using the new point as the second location when the collision rate is less than the collision rate threshold.

The control module 5553 may be further configured to perform at least one of the following processing: increasing a height of a virtual vehicle entering the virtual wind field; increasing a height of a virtual throwable object entering the virtual wind field; and activating a mission or a mechanism associated with a particular interactive object entering the virtual wind field.

When the virtual wind field is located at a slope in the virtual scene, the determining module 5555 may be further configured to: before the control module 5553 increases the height of the virtual vehicle or the virtual throwable object entering the virtual wind field, use a projection point of the virtual vehicle or the virtual throwable object at a plane of the virtual wind field close to the ground as a detection start point; the control module 5553 may be further configured to: control the detection start point to be offset upwards by a distance corresponding to a gradient value of the slope, the distance being positively correlated to the gradient value; and transmit a detection ray to the virtual vehicle or the virtual throwable object from the detection start point after the offset; and the determining module 5555 may be further configured to determine, when a detection result indicates that there is no blockage, to increase the height of the virtual vehicle or the virtual throwable object entering the virtual scene; and may be configured to determine, when a detection result indicates that there is a blockage, not to increase the height of the virtual vehicle or the virtual throwable object entering the virtual scene.

The virtual scene interaction apparatus 555 further includes a shielding module 5556, and may be configured to: after creating a virtual wind field at the second location when there is a terrain object at the second location, shield the terrain object from blocking wind in the virtual wind field in a process of controlling the wind in the virtual wind field to move upwards from the ground.

After creating a virtual wind field at the second location when there is a non-terrain object at the second location, the shielding module 5556 may be further configured to shield the non-terrain object from blocking wind in the virtual wind field in a process of controlling the wind in the virtual wind field to move upwards from the ground when the non-terrain object is a wind-permeable object; and the determining module 5555 may be further configured to determine, when the non-terrain object is a non-wind-permeable object in the process of controlling the wind in the virtual wind field to move upwards from the ground, that at least some wind in the virtual wind field is blocked by the non-terrain object.

The descriptions of the apparatus are similar to the foregoing descriptions of the method, have beneficial effects similar to those of the method, and therefore are not described in detail. Technical details that are not completed in the virtual scene interaction apparatus may be understood according to descriptions in any one of FIG. 3, FIG. 4, or FIG. 5.

One or more aspects described herein provides a computer program product, where the computer program product includes a computer program or computer executable instructions, and the computer program or the computer executable instructions are stored in a non-transitory computer-readable storage medium. A processor of a computer device reads the computer executable instructions from the non-transitory computer-readable storage medium, and executes the computer executable instructions, to cause the computer device to perform the virtual scene interaction method described herein.

One or more aspects described herein provides a non-transitory computer-readable storage medium, having computer executable instructions stored therein, the computer executable instructions, when executed by a processor, causing the processor to perform the virtual scene interaction method, for example, the virtual scene interaction method shown in FIG. 3, FIG. 4, or FIG. 5.

The non-transitory computer-readable storage medium may be a memory such as an FRAM, a ROM, a PROM, an EPROM, an EEPROM, a flash memory, a magnetic surface memory, an optical disc, or a CD-ROM; or may be any device that includes one or any concatenation of the foregoing memories.

The executable instructions may be compiled in a form of a program, software, a software module, a script, or code, in any form of a programming language (including a compilation or interpretation language, or a declarative or procedural language), and may be deployed in any form, including being deployed as an independent program or as a module, component, subroutine, or another unit suitable for use in a computing environment.

As an example, the executable instruction may be deployed on one electronic device for execution, or executed on a plurality of electronic devices located at one location, or executed on a plurality of electronic devices distributed at a plurality of locations and interconnected by using a communications network.

The foregoing descriptions are not intended to limit the protection scope. Any modification, equivalent replacement, or improvement made within the spirit and principle of the foregoing description shall fall within the protection scope.

What is claimed is:

1. A virtual scene interaction method, performed by an electronic device and comprising:
outputting for display in a graphical user interface a virtual scene, a skill selection control, and a skill release control, the virtual scene comprising a first virtual object, the skill release control being in a first display style, and the first display style representing that the skill release control is currently associated with a first skill;
switching the skill release control from the first display style to a second display style in response to a trigger operation for the skill selection control, the second display style representing that the skill release control is currently associated with a second skill, the second skill comprising a plurality of types, and the skill selection control used for selecting one target type from the plurality of types; and
controlling the first virtual object to release the second skill of the target type in response to a trigger operation for the skill release control.

2. The virtual scene interaction method according to claim 1, wherein the skill selection control is in a disabled state by default, and the disabled state represents that the second skill is in an inactive state, and the method further comprises:
switching, based on the trigger operation for the skill selection control, the skill selection control from the disabled state to an enabled state, the enabled state representing that the second skill is in an active state.

3. The virtual scene interaction method according to claim 2, wherein:
the target type is a first type selected by default from the plurality of types,
a default display style of the skill selection control is a third display style,
the third display style represents that the skill selection control is currently associated with the second skill of the first type, and
the first type comprises one of a type selected last time or a type selected for a largest quantity of times.

4. The virtual scene interaction method according to claim 2, wherein the target type is a second type manually selected by using the skill selection control, and the method further comprises:
outputting for display a plurality of types of second skills in response to a trigger operation for the skill selection control in the enabled state; and
switching the skill selection control to a fourth display style based on a determination that the second type in the plurality of types is selected, the fourth display style representing that the skill selection control is currently associated with the second skill of the second type.

5. The virtual scene interaction method according to claim 1, wherein a type of the trigger operation comprises a tap operation, and wherein the controlling the first virtual object to release the second skill of the target type in response to a trigger operation for the skill release control comprises:
based on the tap operation for the skill release control, controlling the first virtual object to release the second skill of the target type towards a first direction to drive a first virtual prop to autonomously move along the first direction and to apply a corresponding effect to an object colliding with the first virtual prop, the first direction being a current orientation of the first virtual object.

6. The virtual scene interaction method according to claim 1, wherein a type of the trigger operation comprises a press operation, and the controlling the first virtual object to release the second skill of the target type in response to a trigger operation for the skill release control comprises:
switching, based on the press operation for the skill release control, the virtual scene to a magnification mode in a period in which the press operation is not released;
outputting for display a virtual joystick and a crosshair corresponding to an orientation of the first virtual object;
controlling, based on a shake operation for the virtual joystick, the crosshair to synchronously rotate; and
based on the press operation being released, controlling the first virtual object to release the second skill of the target type towards a second direction to drive a first virtual prop to autonomously move along the second direction, and to apply a corresponding effect to an object colliding with the first virtual prop, the second direction being a direction corresponding to the crosshair after the rotation.

7. The virtual scene interaction method according to claim 6, wherein based on the press operation for the skill release control, the method further comprises:
controlling the second skill of the target type to enter a charge state, wherein at least one of prominence of the first virtual prop or an influence range of the first virtual prop increases as a charge level increases, the charge level being positively correlated to a duration of the press operation; and
controlling, based on the press operation being released, the second skill of the target type to exit the charge state.

8. The virtual scene interaction method according to claim 7, wherein the controlling the second skill of the target type to enter a charge state comprises:
outputting for display a status progress control in the graphical user interface, wherein a progress of the status progress control continuously decreases as the duration of the press operation increases, and wherein the progress of the status progress control represents a remaining status value of the first virtual object.

9. The virtual scene interaction method according to claim 5, wherein the applying a corresponding effect to an object colliding with the first virtual prop comprises at least one of the following:
knocking down a collided second virtual object;
outputting for display a collision identifier on a collided third virtual object to increase a capture probability of the first virtual object for the third virtual object;
destroying a collided virtual object; or
activating a mechanism associated with a particular collided interactive object.

10. The virtual scene interaction method according to claim 5, wherein the driving the first virtual prop to autonomously move along the first direction or the second direction further comprises:
driving the first virtual prop to bounce for a specified quantity of time when encountering a ground or an obstacle.

11. The virtual scene interaction method according to claim 10, wherein after driving the first virtual prop to bounce for the specified quantity of times, the method further comprises:
canceling display of the first virtual prop in the virtual scene; or
controlling the first virtual prop to explode to destroy a virtual object colliding with the first virtual prop.

12. The virtual scene interaction method according to claim 10, wherein the driving the first virtual prop to bounce when encountering a ground or an obstacle comprises:
limiting movement of the first virtual prop to a plane with the bounce direction being a forward direction or a backward direction along the plane, the plane being a plane formed by a throwing direction and an anti-gravity direction of the first virtual prop;
determining an elevation angle and a speed of bouncing of the first virtual prop, the elevation angle and the speed being positively correlated to a charge level; and
driving the first virtual prop to bounce according to the bounce direction, the elevation angle, and the speed.

13. The virtual scene interaction method according to claim 10, wherein driving the first virtual prop to bounce comprises:
multiplying displacement of the first virtual prop in each frame by a specified adjustment coefficient so that a height of the first virtual prop during each bounce is the same; or
attenuating a flight speed of the first virtual prop in each frame based on a deceleration coefficient that conforms to a motion law.

14. The virtual scene interaction method according to claim 1, wherein:
the type of the trigger operation comprises a tap operation, and
the controlling the first virtual object to release the second skill of the target type in response to a trigger operation for the skill release control comprises:
controlling, based on the tap operation for the skill release control, the first virtual object to release the second skill of the target type at a first location, create a virtual wind field at the first location, and apply a corresponding effect to an object entering the virtual wind field, the first location being a location of the first virtual object.

15. A non-transitory computer readable storage medium storing instructions that when executed one or more processors, cause the one or more processors to:
output for display in a graphical user interface a virtual scene, a skill selection control, and a skill release control, the virtual scene comprising a first virtual object, the skill release control being in a first display style, and the first display style representing that the skill release control is currently associated with a first skill;
switch the skill release control from the first display style to a second display style in response to a trigger operation for the skill selection control, the second display style representing that the skill release control is currently associated with a second skill, the second skill comprising a plurality of types, and the skill selection control used for selecting one target type from the plurality of types; and
control the first virtual object to release the second skill of the target type in response to a trigger operation for the skill release control.

16. The non-transitory computer readable storage medium according to claim 15, wherein the skill selection control is in a disabled state by default, and the disabled state represents that the second skill is in an inactive state, and further comprising instructions that when executed by the one or more processors, cause the one or more processors to:
switch, based on in response to the trigger operation for the skill selection control, the skill selection control from the disabled state to an enabled state, the enabled state representing that the second skill is in an active state.

17. The non-transitory computer readable storage medium according to claim 16, wherein:
the target type is a first type selected by default from the plurality of types,
a default display style of the skill selection control is a third display style,
the third display style represents that the skill selection control is currently associated with the second skill of the first type, and
the first type comprises one of a type selected last time or a type selected for a largest quantity of times.

18. The non-transitory computer readable storage medium according to claim 16, wherein the target type is a second type manually selected by using the skill selection control, and further comprising instructions that when executed by the one or more processors, cause the one or more processors to:
output for display a plurality of types of second skills in response to a trigger operation for the skill selection control in the enabled state; and
switch the skill selection control to a fourth display style based on a determination that the second type in the plurality of types is selected, the fourth display style representing that the skill selection control is currently associated with the second skill of the second type.

19. An apparatus comprising:
one or more processors; and
memory storing instructions that when executed by the one or more processors, cause the apparatus to:
output for display in a graphical user interface a virtual scene, a skill selection control, and a skill release control, the virtual scene comprising a first virtual object, the skill release control being in a first display style, and the first display style representing that the skill release control is currently associated with a first skill;
switch the skill release control from the first display style to a second display style in response to a trigger operation for the skill selection control, the second display style representing that the skill release control is currently associated with a second skill, the second skill comprising a plurality of types, and the skill selection control used for selecting one target type from the plurality of types; and
control the first virtual object to release the second skill of the target type in response to a trigger operation for the skill release control.

20. The apparatus according to claim 19, wherein the skill selection control is in a disabled state by default, and the disabled state represents that the second skill is in an inactive state, and further comprising instructions that when executed by the one or more processors, cause the apparatus to:
switch, based on in response to the trigger operation for the skill selection control, the skill selection control from the disabled state to an enabled state, the enabled state representing that the second skill is in an active state.
